(19) United States
(12) Patent Application Publication
(10) Pub. No.: US 2014/0176283 A1
(43) Pub. Date: Jun. 26, 2014

(54) COMMON MODE FILTER AND METHOD OF MANUFACTURING THE SAME

(71) Applicant: Samsung Electro-Mechanics Co., Ltd., Suwon-si (KR)

(72) Inventors: Ju Hwan YANG, Suwon-si (KR); Sung Kwon WI, Suwon-si (KR); Jang Su KIM, Suwon-si (KR); Geon Se CHANG, Suwon-si (KR); Young Do KWEON, Suwon-si (KR)

(73) Assignee: SAMSUNG ELECTRO-MECHANICS CO., LTD., Suwon-si (KR)

(21) Appl. No.: 14/139,109

(22) Filed: Dec. 23, 2013

(30) Foreign Application Priority Data
Dec. 26, 2012 (KR) 10-2012-0153487

(51) Int. Cl. H01F 17/00; H01F 41/04

(52) U.S. Cl. CPC H01F 17/0006; H01F 41/046
USPC 336/200; 29/602.1

(57) ABSTRACT

Disclosed herein are a common mode filter for increasing inductance using simpler structure and a method of manufacturing the same, the common mode filter including: a magnetic material substrate; an insulating layer included on an upper portion of the magnetic material substrate and having a coil electrode formed therein; an opening part penetrating through a central portion of the insulating layer; and a magnetic composite formed in the opening part, wherein the opening part has a side wall inclined at a predetermined angle.

### CROSS REFERENCE(S) TO RELATED APPLICATIONS

This application claims the foreign priority benefit under 35 U.S.C. Section 119 of Korean Application No. 10-2012-0153487, entitled “Common Mode Filter and Method of Manufacturing the Same” filed on Dec. 26, 2012, which is hereby incorporated by reference in its entirety into this application.

### BACKGROUND OF THE INVENTION

1. Technical Field

The present invention relates to a common mode filter, and more particularly, to a common mode filter including a unit capable of increasing inductance and a method of manufacturing the same.

2. Description of the Related Art

In accordance with an advancement of technology, electronic devices such as a portable phone, home appliances, a personal computer (PC), a personal digital assistant (PDA), a liquid crystal display (LCD) and the like have converted from the analog method to the digital method and have high-speed characteristics due to an increase in an amount of data to be processed. Therefore, USB 2.0, USB 3.0, and a high-definition multimedia interface (HDMI) have come into wide use as a high-speed signal transmission interface and have been used in many digital devices such as a personal computer and a digital high-definition television.

These interfaces employ a differential signal system transmitting a differential signal (a differential mode signal) using a pair of signal lines unlike a single-end transmission system generally used for a long time. However, the electronic devices which are digitalized and have high-speed characteristics is sensitive to stimulation from the outside. That is, in the case in which small abnormal voltage and high frequency noise from the outside are introduced into an inner circuit of the electronic device, a case damaging the circuit or distorting a signal is generated.

In this case, examples of a cause generating the circuit damage of the electronic device and the signal distortion include lightning, electrostatic discharge charged to a human body, switching voltage generated in a circuit, power noise included in power voltage, an unnecessary electromagnetic signal, electromagnetic noise, or the like. In order to prevent the above-mentioned generation of the circuit damage of the electronic device or the signal distortion, a filter is installed so as to prevent abnormal voltage and high frequency noise from being introduced into the circuit.

Generally, in order to remove common mode noise, a common mode filter is used in a high-speed differential signal line and the like. The common mode noise is noise generated in the differential signal line, and the common mode filter removes noise which may not be removed by an existing electromagnetic interference (EMI) filter. The common mode filter contributes to an improvement of electromagnetic compatibility (EMC) characteristics of home appliances and the like or an improvement of antenna characteristics of a mobile phone and the like.

Referring to Japanese Patent Laid-Open Publication No. 2012-015494, a general common mode filter according to the related art has a structure in which magnetic members are included on upper and lower portions of a pair of primary and secondary conductor coils surrounded by an insulating resin.

In the case in which current flows in the conductor coil through an external electrode terminal in the above-mentioned structure, magnetic flux is generated around the conductor coil. In this case, an effort for improving characteristics of the common mode filter continues, such as for example, making an interval between the primary and secondary conductor coils small in order to increase a degree of electromagnetic coupling, or increasing the turn number of the conductor coil in order to implement high inductance H and so on.

However, the above-mentioned technology has a space limitation due to slimness and miniaturization of an element, processes for implementing the above-mentioned technology have become complicated, and a sufficient effect of improving the characteristics of the common mode filter is not obtained as compared to complexity of the processes, such that a technology capable of improving the common mode filter using a simpler structure has been urgently demanded.

### RELATED ART DOCUMENT

### Patent Document

(Patent Document 1) Japanese Patent Laid-Open Publication No. 2012-015494

### SUMMARY OF THE INVENTION

An object of the present invention is to provide a common mode filter capable of increasing inductance by making flow of magnetic flux smooth using a simpler structure without separately added processes and a method of manufacturing the same, thereby improving productivity of a product and decreasing manufacturing costs.

According to an exemplary embodiment of the present invention, there is provided a common mode filter, including: a magnetic material substrate; an insulating layer included on an upper portion of the magnetic material substrate and having a coil electrode formed therein; an opening part penetrating through a central portion of the insulating layer; and a magnetic composite formed in the opening part, wherein the opening part has a side wall inclined at a predetermined angle.

A ratio of a width w1 of a bottom surface of the opening part and a width w2 of an element of the common mode filter may be 0.01:1 to 0.2:1.

An angle θ between the side wall of the opening part and a horizontal line may be above 45° to below 90°.

The magnetic composite may include a soft magnetic metal and a ferrite as main components thereof.

The magnetic composite may have a cross-section of an oval shape or a quadrangle shape.

The coil electrode may be configured of a primary coil electrode and a secondary coil electrode electromagnetically coupled to each other.

The common mode filter may further include external electrodes formed on the upper surface of the insulating layer and connected to each of both ends of the coil electrode, and a magnetic composite formed between the external electrodes.

According to another exemplary embodiment of the present invention, there is provided a method of manufacturing a common mode filter, the method including: repeatedly forming a coil conductor and an insulating resin covering the coil conductor on one surface of a magnetic material substrate to form an insulating layer surrounding a coil electrode; firing the insulating layer; processing an opening part penetrating through a central portion of the insulating layer; and forming a magnetic composite in the opening part, wherein the opening part has a side wall processed to be inclined at a predetermined angle.

The opening part may be formed by a laser method.

The magnetic composite may be formed by filling and then curing a magnetic paste having a soft magnetic metal powder and a ferrite powder mixed as main components in the opening part.

After external electrodes connected to an end portion of the coil electrode are plated and formed with a predetermined thickness on an upper surface of the insulating layer, a magnetic paste having a soft magnetic metal powder and a ferrite powder mixed as main components may be filled and then cured in the opening part as well as between the external electrodes.

### BRIEF DESCRIPTION OF THE DRAWINGS

FIG. 1 is an appearance perspective view of a common mode filter according to an exemplary embodiment of the present invention;

FIG. 2 is a cross-sectional view taken along the line I-I′ of FIG. 1;

FIG. 3 is an inner plan view of the common mode filter according to the exemplary embodiment of the present invention;

FIG. 4 is an inner plan view for describing another form of a coil electrode included in the exemplary embodiment of the present invention;

FIG. 5 is a cross-sectional view illustrating a case in which an angle between a side wall of an opening part and a horizontal line is 60 degree;

FIG. 6 is a cross-sectional view illustrating a case in which an angle between the side wall of the opening part and the horizontal line is 45 degree; and

FIGS. 7 to 10 are process views sequentially showing a method of manufacturing the common mode filter according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

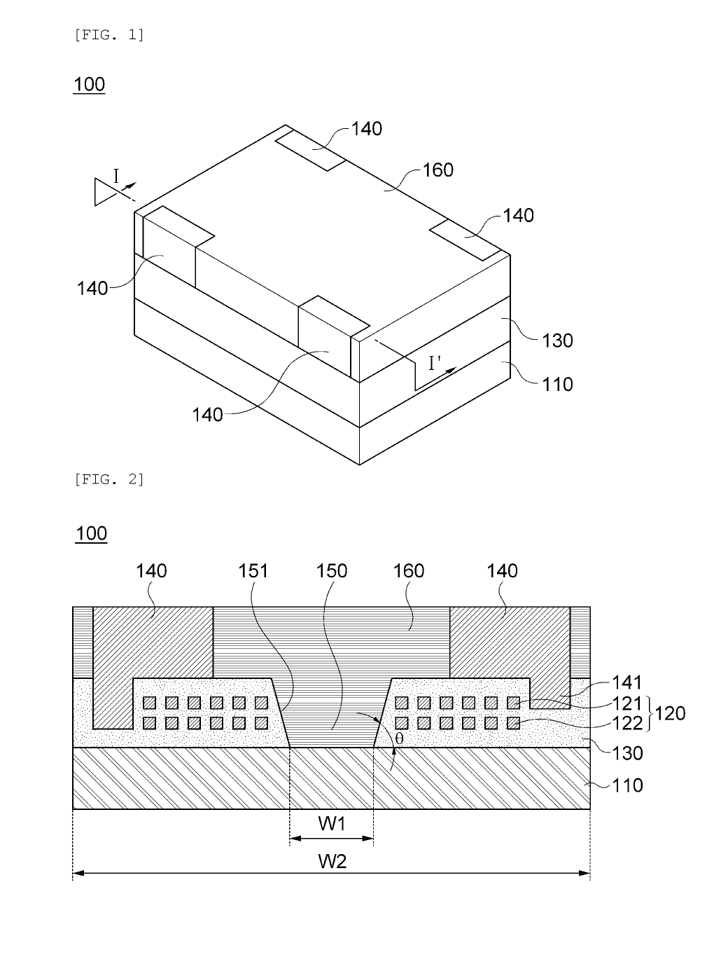

FIG. 1 is an appearance perspective view of a common mode filter according to an exemplary embodiment of the present invention and FIG. 2 is a cross-sectional view taken along the line I-I′ of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscured.

Referring to FIGS. 1 and 2, a common mode filter 100 according to the exemplary embodiment of the present invention may include a magnetic material substrate 110, and an insulating layer 130 included on the magnetic material substrate 110 and having a coil electrode 120 formed therein.

The magnetic material substrate 110 is made of Ni—Zn, Mn—Zn based, Ni—Zn based, Ni—Zn—Mg based, Mn—Mg—Zn based ferrites, or a mixture thereof having high electric resistance, having small magnetic force loss, and capable of easily designing impedance by changing composition thereof to become a space forming a magnetic path.

The coil electrode 120 which is a conductor plated in a spiral shape on a co-plane, may be configured of a primary coil electrode 121 and a secondary coil electrode 122 spaced from each other by a predetermined interval having an insulating resin which is a configuration material of the insulating layer 130 therebetween to be electromagnetically coupled to each other. Alternatively, each of the primary coil electrode 121 and the secondary coil electrode 122 is configured in plural and is disposed to be spaced from each other, or the primary coil electrode 121 and the secondary coil electrode 122 may be simultaneously plated on the co-plane.

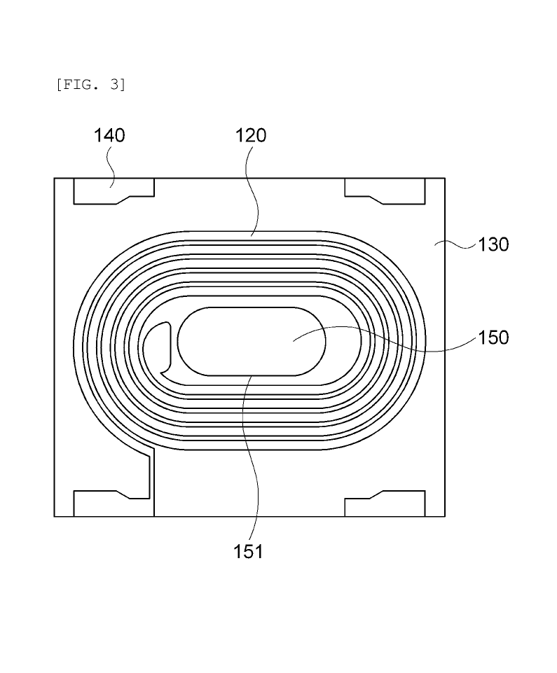

The above-mentioned coil electrode 120 may be formed at an outside portion of the insulating layer 130 as shown in FIG. 3 when viewing the insulating layer 130 from above, the central portion of the insulating layer 130 may be provided with an opening part 151 penetrating through the insulating layer 130, and a magnetic composite 150 may be formed in the opening part 151. That is, the coil electrode 120 is formed in a form wound around the magnetic composite 150.

In this case, the coil electrode 120 may be a form wound in an oval shape as shown in FIG. 3 or may be a form wound in a polygon shape such as a quadrangle and the like as shown in FIG. 4. Correspondingly, a cross-section of the magnetic composite 150 may also be the oval shape as shown in FIG. 3 or may be the quadrangle as shown in FIG. 4.

Meanwhile, the common mode filter 100 according to the exemplary embodiment of the present invention may further include external electrodes 140 formed on an upper surface of the insulating layer 130 and connected to an end portion of the coil electrode 120 through a connection terminal 141, and a magnetic composite 160 may be formed between the external electrodes 140. Here, the magnetic composite 150 in the opening part 151 and the magnetic composite 160 between the external electrodes 140 may be formed integrally with each other.

According to the structure as described above, the magnetic flux generated at the coil electrode 120 is connected through the magnetic material substrate 110, the magnetic composite 160 between the external electrodes 140, and the magnetic composite 150 in the opening part 151, thereby making it possible to significantly improve inductance. As described above, characteristics of the present invention is the magnetic composite 150 formed in the opening part 151 and unless separately being described, the term which is referred to as the magnetic composite below indicates the magnetic composite 150 formed in the opening part 151.

Meanwhile, a side wall of the opening part 151 may be inclined at a predetermined angle and a ratio between a width w1 of a bottom surface of the opening part 151 and a width w2 of a chip element may be 0.01:1 to 0.2:1.

The ratio is calculated by considering both inductance increase effects due to the coil turn number of the coil electrode 120 and the magnetic composite 150, and when the bottom surface of the opening part 151 has a significantly small width w1 to thereby become below the ratio, it is difficult to recognize as an opening part form, such that the inductance increase effect due to the magnetic composite 150 does not appear. On the other hand, when the bottom surface of the opening part 151 has a significantly large width w1 to thereby exceed the ratio, the maximum inductance may not be obtained due to a decrease in the coil turn number of the coil electrode 120.

However, the ratio is a value employing a chip size and a currently plating process technology as parameters and in the case in which more coil turn number may be plated in a limited space due to a smaller chip size and an advancement of the plating process technology, the ratio may be changed.

Meanwhile, as an angle θ between the side wall of the opening part 151 and the horizontal line is smaller, a filling volume of the magnetic composite 150 increases, such that high inductance may be implemented. However, when the angle is significantly small, a conductor of the innermost coil electrode 120 among the coil electrode 120 is exposed to the outside and the exposed conductor is removed, thereby decreasing inductance due to the decrease in the coil turn number of the coil electrode 120.

The following Table 1 is a table showing the inductances measured according to the angle θ between the side wall of the opening part 151 and the horizontal line. Referring to Table 1, it may be appreciated in a range of above 60° to 90° or less that as the angle θ is smaller, the inductance is increased due to an increase in the filling volume of the magnetic composite 150.

TABLE 1

| | | DECREASED COIL TURN NUMBER |
|---|---|---|
| ANGLE (θ) | INDUCTANCE | OF COIL ELECTRODE |
| 90 | 1000 | — |
| 89 | 1035 | — |
| 88 | 1070 | — |
| 87 | 1105 | — |
| 86 | 1140 | — |
| 85 | 1175 | — |
| 84 | 1210 | — |
| 83 | 1246 | — |
| 82 | 1281 | — |
| 81 | 1317 | — |
| 80 | 1353 | — |
| 70 | 1728 | — |
| 60 | 1724 | 1 TURN |
| 50 | 2143 | 1 TURN |
| 45 | 1500 | 3 TURN |
| 40 | 1692 | 3 TURN |
| 39 | 1735 | 3 TURN |
| 38 | 1780 | 3 TURN |
| 37 | 1827 | 3 TURN |
| 36 | 1876 | 3 TURN |
| 35 | 1928 | 3 TURN |
| 34 | 1983 | 3 TURN |
| 33 | 2040 | 3 TURN |
| 32 | 2100 | 3 TURN |
| 31 | 2164 | 3 TURN |
| 30 | 2232 | 3 TURN |

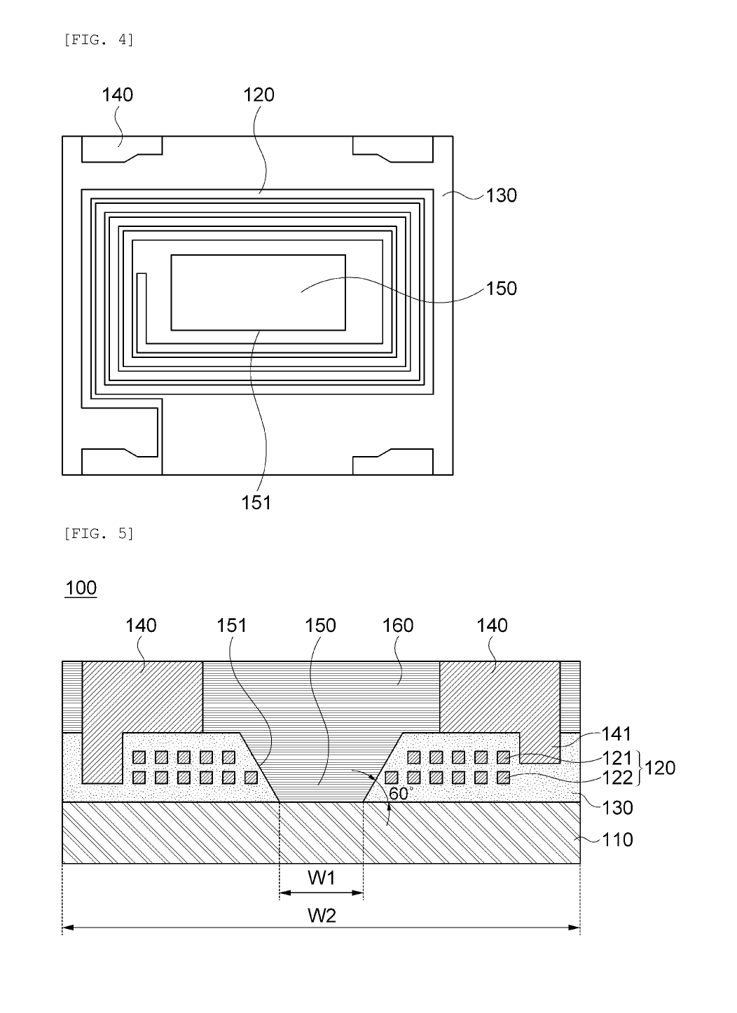

It is noticeable in Table 1 that although the angle θ becomes 60° to thereby decrease the coil turn number of a primary coil electrode 121 of an upper layer by one turn due to a gradient as shown in FIG. 5, a decrease width of the inductance is not large as compared to a case in which the angle is 70° without the decrease in the coil turn number. It means that the inductance lost according to the decrease of the coil turn number of the coil electrode 120 by one turn is sufficiently compensated and this compensation effect is equally observed in a range of above 45° to below 60° in which the coil turn number is decreased by one turn due to the gradient.

However, as shown in FIG. 6, as a tangent value becomes one in the case in which the angle θ is 45°, the coil turn number of the coil electrode 120 decreased due to the gradient becomes a total of three turns that are the coil turn number (two turns) of the primary coil electrode 121 disposed at an upper layer and the coil turn number (one turn) of the second coil electrode 122 disposed at a lower layer, such that the inductance is sharply decreased. Therefore, it is preferred to set the angle θ between the side wall of the opening part 151 and the horizontal line in a range of above 45° to below 90°.

Hereinafter, a method of manufacturing a common mode filter 100 according to an exemplary embodiment of the present invention will be described.

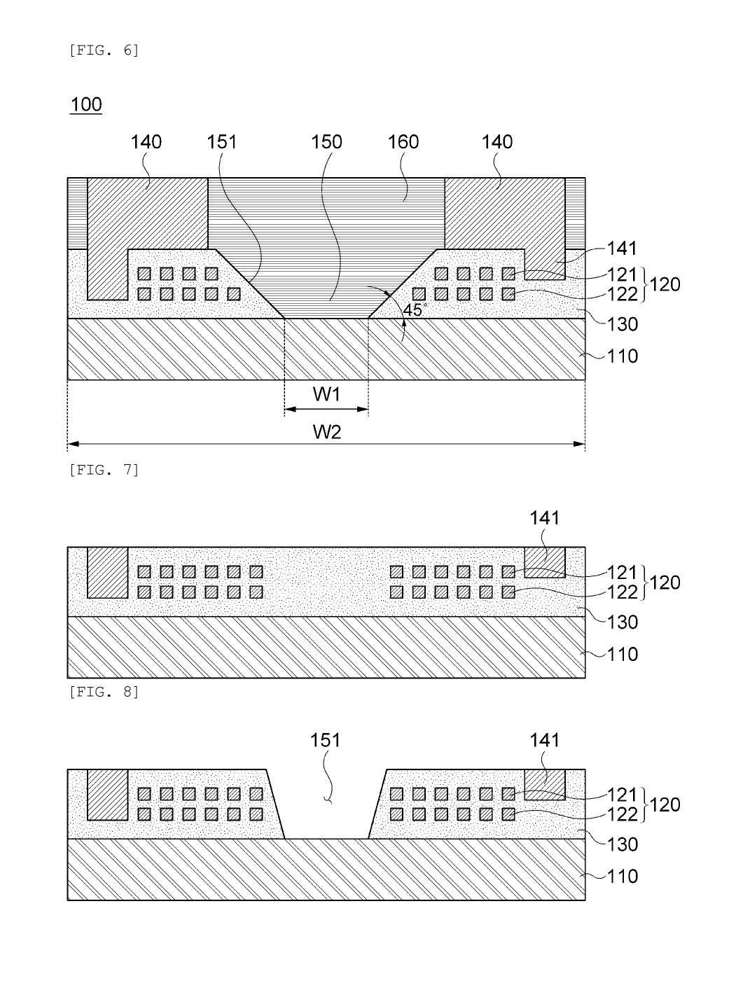

FIGS. 7 to 10 are process views sequentially showing a method of manufacturing the common mode filter 100 according to the exemplary embodiment of the present invention and the method of manufacturing the common mode filter 100 according to the exemplary embodiment of the present invention first repeatedly forms a coil conductor and an insulating resin covering the coil conductor on one surface of the magnetic material substrate 110 to form an insulating layer 130 surrounding the coil electrode 120, as shown in FIG. 7.

The insulating resin may be applied using a general known technology such as a dip coating method, a spin coating method, or the like and the insulating resin of each layer is then integrated through a curing process.

In addition, the coil electrode 120 may be formed using general known technologies such as a subtract method, an additive method, a semi-additive method, and the like. In this case, it is preferred to plate together a connection terminal 141 for electrically connecting to the external electrode.

When the insulating resin is applied up to the uppermost layer, the insulating resin is thermally processed under a predetermined condition, such that the insulating layer 130 is cured. In this case, according to the thermal process condition, an inclined angle θ of the opening part 151 formed in a subsequent step may be determined.

When the thermal process is completed, the opening part 151 penetrating through the insulating layer 130 is processed in a central portion of the insulating layer 130 as shown in FIG. 8. In this case, since the insulating layer 130 has photosensitive characteristics, the opening part 151 as necessary may be patterned by irradiating and reacting ultra violet UV to the insulating layer 130. Alternatively, the opening part 110a may be patterned using laser methods such as excimer laser, YAG laser, CO₂ laser, or the like.

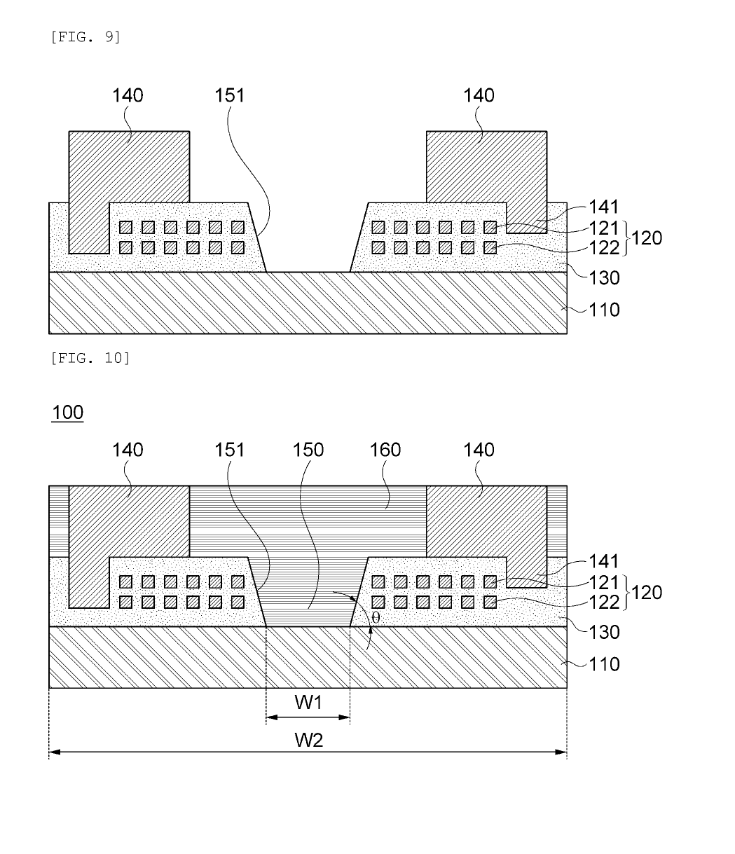

Next, after the external electrode 140 connected to the end portion of the coil electrode 120 is plated at a predetermined thickness on the upper surface of the insulating layer 130 as shown in FIG. 9, a magnetic paste is filled and cured in the opening part 151 as well as between the external electrodes 140, thereby making it possible to finally complete the common mode filter 100 according to the exemplary embodiment of the present invention.

The magnetic paste is a magnetic material of a slurry form in which soft magnetic metal powder and ferrite powder are mixed as main components thereof. In the case in which the magnetic paste is introduced between the external electrodes 140, when the magnetic paste is filled from an inner portion of the opening part 151 to be filled up to a height of the external electrode 140, it is fired and cured. Therefore, the magnetic composite 160 between the external electrodes 140 and the magnetic composite 150 in the opening part 151 are formed integrally with each other.

The common mode filter according to the exemplary embodiment of the present invention may increase the inductance of the common mode filter using a simpler process without separately added processes, thereby making it possible to increase productivity of the product and decrease the manufacturing costs.

The above detailed description has illustrated the present invention. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A common mode filter, comprising:
a magnetic material substrate;
an insulating layer included on an upper portion of the magnetic material substrate and having a coil electrode formed therein;
an opening part penetrating through a central portion of the insulating layer; and
a magnetic composite formed in the opening part,
wherein the opening part has a side wall inclined at a predetermined angle.

2. The common mode filter according to claim 1, wherein a ratio of a width w1 of a bottom surface of the opening part and a width w2 of an element of the common mode filter is 0.01:1 to 0.2:1.

3. The common mode filter according to claim 1, wherein an angle θ between the side wall of the opening part and a horizontal line is above 45° to below 90°.

4. The common mode filter according to claim 1, wherein the magnetic composite includes a soft magnetic metal and a ferrite as main components thereof.

5. The common mode filter according to claim 1, wherein the magnetic composite has a cross-section of an oval shape or a quadrangle shape.

6. The common mode filter according to claim 1, wherein the coil electrode is configured of a primary coil electrode and a secondary coil electrode electromagnetically coupled to each other.

7. The common mode filter according to claim 1, further comprising external electrodes formed on the upper surface of the insulating layer and connected to each of both ends of the coil electrode, and a magnetic composite formed between the external electrodes.

8. A method of manufacturing a common mode filter, the method comprising:
repeatedly forming a coil conductor and an insulating resin covering the coil conductor on one surface of a magnetic material substrate to form an insulating layer surrounding a coil electrode;
firing the insulating layer;
processing an opening part penetrating through a central portion of the insulating layer; and
forming a magnetic composite in the opening part,
wherein the opening part has a side wall processed to be inclined at a predetermined angle.

9. The method according to claim 8, wherein the opening part is formed by a laser method.

10. The method according to claim 8, wherein the magnetic composite is formed by filling and then firing a magnetic paste having a soft magnetic metal powder and a ferrite powder mixed as main components in the opening part.

11. The method according to claim 8, wherein after external electrodes connected to an end portion of the coil electrode are plated and formed at a predetermined thickness on an upper surface of the insulating layer, a magnetic paste having a soft magnetic metal powder and a ferrite powder mixed as main components is filled and then fired in the opening part as well as between the external electrodes.
